(19) United States
(12) Patent Application Publication
(10) Pub. No.: US 2013/0007806 A1
(43) Pub. Date: Jan. 3, 2013

(54) APPARATUS AND METHOD FOR DISPLAYING PROGRAM GUIDE INFORMATION ON A DISPLAY

(76) Inventors: Steven Charles Rhoads, Carmel, IN (US); Robert Andrew Rhodes, Carmel, IN (US)

(21) Appl. No.: 13/634,610

(22) PCT Filed: Mar. 22, 2011
(86) PCT No.: PCT/US2011/029300

§ 371 Date: Sep. 13, 2012

Related U.S. Application Data
(60) Provisional application No. 61/316,073, filed on Mar. 22, 2010.

(51) Int. Cl. H04N 21/482

(52) U.S. Cl. 725/41

(57) ABSTRACT

An apparatus and method for providing program guide information to an end user are provided. The apparatus and method maps portions of a grid database based on a set of selected channels, then increments the display periodically by replacing one of the channel elements in the display with a new channel from the selected channels in the database. The apparatus and method provide for acquiring program content information for a plurality of broadcast channels, outputting a first video image representing program content covering a time span for a first portion of the plurality of channels, and outputting a second video image representing the program content covering the time span for a second portion of the plurality of channels after outputting the first image for a time period, the second portion including at least one channel from the plurality of channels not included in the first portion.

### REFERENCE TO RELATED PROVISIONAL APPLICATION

This application claims the benefit under 35 U.S.C. §119 of provisional application No. 61/316,073 filed in the United States on Mar. 22, 2010.

### TECHNICAL FIELD OF THE INVENTION

The present disclosure generally relates to digital content systems and methods for delivering content to an end user, and more particularly, to a system and method for providing program guide information to an end user.

### BACKGROUND OF THE INVENTION

Multiple dwelling hospitality units, such as hotels and motels, often utilize in house distribution systems for providing broadcast and other video services to each of the rooms. These systems often use repackaged cable broadcast services and provide these to the customers' rooms. In the typical repackaged broadcast services redistribution system, signals are converted to an encrypted digital cable distribution system for hotels. In this system, the receivers are televisions (TVs) that can't decode program guide database information. The TVs also don't have the capability to render bitmap displays of the guide information. Further, the TVs don't have a back channel path to the main distribution device, often referred to as a gateway or head-end device, so the information is only broadcast from the device to the TVs. Finally, these systems often do not include a real-time compressed video encoder, such as a Motion Picture Entertainment Group standard MPEG-2 encoder.

Standard satellite set-top-boxes receive and decode the program guide database information and then render bitmap displays of the guide. The guide information is accessible through a user interface feature, and typically allows complete navigation through all of the guide information contents. The TV receivers in the hotel rooms do not include the capability to directly decode the program guide database information, store the program guide database, or render a guide as a bitmap display.

Traditionally, cable companies have addressed this problem by creating a scrolling guide by using a full real-time MPEG video encoder, thereby creating a separate broadcast channel.

There is a need for a simpler solution to address the delivery of program guide information to receivers and for displaying the program guide information.

### SUMMARY

According to one aspect of the present disclosure, a method for outputting channel guide information is provided, the method including acquiring program content information for a plurality of broadcast channels, outputting a first video image representing program content covering a time span for a first portion of the plurality of channels, and outputting a second video image representing the program content covering the time span for a second portion of the plurality of channels after outputting the first image for a time period, the second portion including at least one channel from the plurality of channels not included in the first portion.

According to another aspect of the present disclosure, an apparatus for outputting channel guide information includes a tuner that acquires program content information for a plurality of broadcast channels, and an interface that outputs a first video image representing program content covering a time span for a first portion of the plurality of channels and outputs a second video image representing the program content covering the time span for a second portion of the plurality of channels after outputting the first image for a time period, the second portion including at least one channel from the plurality of channels not included in the first portion.

### BRIEF DESCRIPTION OF THE DRAWINGS

These, and other aspects, features and advantages of the present disclosure will be described or become apparent from the following detailed description of the preferred embodiments, which is to be read in connection with the accompanying drawings.

In the drawings, wherein like reference numerals denote similar elements throughout the views:

FIG. 1 is a block diagram of an exemplary embodiment of a system for delivering video content in accordance with the present disclosure;

FIG. 2 is a block diagram of an exemplary embodiment of a system for providing program guide information to an end user in accordance with the present disclosure;

FIG. 3 is a flowchart of an exemplary embodiment of a process for generating program guide information in accordance with the present disclosure;

FIG. 4 is a flowchart of an exemplary embodiment of a process for displaying program guide information in accordance with the present disclosure; and

FIG. 5A and FIG. 5B are exemplary views of a program guide generated in accordance with the present disclosure.

It should be understood that the drawings are for purposes of illustrating the concepts of the disclosure and is not necessarily the only possible configuration for illustrating the disclosure.

### DETAILED DESCRIPTION OF PREFERRED EMBODIMENTS

It should be understood that the elements shown in the figures may be implemented in various forms of hardware, software or combinations thereof. Preferably, these elements are implemented in a combination of hardware and software on one or more appropriately programmed general-purpose devices, which may include a processor, memory and input/output interfaces. Herein, the phrase “coupled” is defined to mean directly connected to or indirectly connected with through one or more intermediate components. Such intermediate components may include both hardware and software based components.

The present description illustrates the principles of the present disclosure. It will thus be appreciated that those skilled in the art will be able to devise various arrangements that, although not explicitly described or shown herein, embody the principles of the disclosure and are included within its spirit and scope.

All examples and conditional language recited herein are intended for educational purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read only memory (“ROM”) for storing software, random access memory (“RAM”), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

The disclosed embodiments address the display of program guide information delivered as part of the channels that deliver program material in a system using digital televisions that don't support recovery of the guide information as part of the program material including an on-screen-display or a back-channel.

The disclosed embodiments are directed at a system and method for providing a program guide over a multi-dwelling unit content delivery network. The system and method of the present disclosure converts program guide information received from a satellite network, received potentially as a continuously updated stream of data and included as part of the program material, into an independent channel or program stream and delivered as a broadcast channel through the network.

The present disclosure relates to outputting and displaying a channel program guide that is database driven, such as a satellite service provider guide, in a continuous channel based display format. The displayed channel program guide is intended to resemble a conventional channel guide (i.e., tune to a channel and see a scrolling list) found on cable television systems. The system and method of the present disclosure maps portions of a grid database based on a set of selected channels, then increments the display periodically by replacing one of the channel elements in the display with a new channel from the selected channels in the database. The present disclosure also provides for converting the database information to a video image and then to an MPEG video stream for distribution across a network.

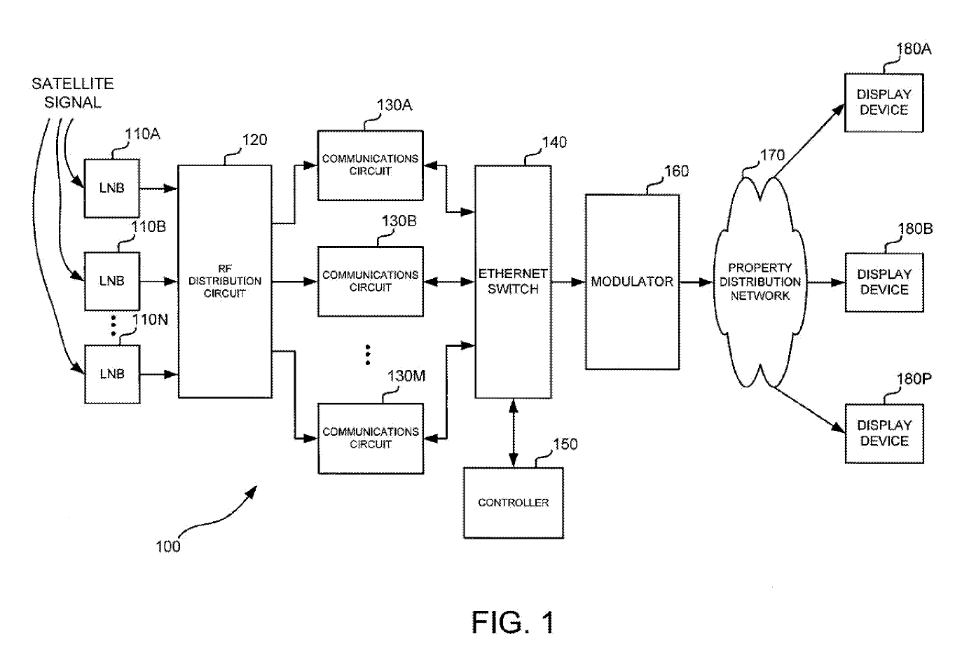

Initially, systems for delivering various types of video content to a user as part of a multi-client delivery network will be described. Turning now to FIG. 1, a block diagram of an embodiment of a system 100 for processing and delivering content to end users in a multi-client network is shown. System 100 shows a system for delivering multiple channel video content provided by a satellite service provider to customer receiver devices, such as televisions, in a multi-dwelling unit network, such as a hotel, motel or other part time residence.

System 100 includes a set of head-end tuner/demodulator circuits. System 100 also includes a series of transport decoders and re-encoders, followed by a set of cable signal modulators. System 100 primarily converts the received signal from a satellite signal format, such as quadrature phase shift keying (QPSK), into an Ethernet signal, such as Internet Protocol. The Ethernet signal is then further converted to a transmitted signal in a cable signal format, such as 256 symbol quadrature amplitude modulation (256-QAM).

In system 100, low noise block converters (LNBs) 110A-110N receive a plurality of satellite signals from a satellite signal service provider. Each of the LNBs 110A-110N is connected to RF distribution circuit 120. The outputs of RF distribution circuit 120 are connected to communications circuits 130A-130M, also known as radio frequency-to-internet protocol (RF-to-IP) circuits. Each of the communications circuits 130A-130M is connected to Ethernet switch 140. The output of the Ethernet switch 140 is connected to modulator 160. A controller 150 is also connected to Ethernet switch 140. The output of modulator 160 is connected into the property distribution network 170. The property distribution network 170 provides signals to each premises unit containing a display device 180A-180P in the multi-client premises (e.g., hotel, motel, apartment).

As mentioned above, the satellite signals are received from a satellite signal service provider. These satellite signals may be received in the form of channels transmitted from a plurality of transponders on several satellites. Each of the LNBs 110A-110N receives the respective satellite signals. LNBs 110A-110N may include separate satellite dish antennas or may share a common satellite dish antenna. The LNBs 110A-110N receive, amplify, and downconvert the satellite signals. In one embodiment, each of the LNBs 110A-110N convert the respective received satellite signals to signal containing a plurality of channels in the 950-2150 Megahertz (MHz) frequency range.

The downconverted satellite signals are provided to the RF distribution circuit 120. RF distribution circuit 120 includes one or more signal switches, splitters, and amplifiers for adjusting, splitting, and recombining the downconverted satellite signals. RF distribution circuit 120 produces a set of signals that permit further demodulation of the received signals. Some of the combining and splitting of the satellite signals may be controlled by downstream circuits, such as the communications circuits 130A-130M. In one embodiment, RF distribution circuit 120 uses a combination of dual voltage polarization switching and digital satellite equipment control (diseqC) signal switching to produce two separate converted satellite signals in the 950-1450 MHz frequency range for each of the communications circuits 130A-130M.

Each of the pairs of converted satellite signals are received by one of the communications circuits 130A-130M. Each of the communications circuits 130A-130M includes circuitry to further downconvert, demodulate and decode the received converted satellite signals to produce one or more program streams. Each program stream may include audio, video and data packets related to content in a media program. The communications circuits 130A-130M also decode the security signals to authorize and validate the received programs as required by the service provider. Communications circuits 130A-130M may also include circuitry for re-packaging the decoded program streams into one or more internet protocol streams of data packets for output as an Ethernet signal. Communications circuits 130A-130M also include circuitry for transcoding the program streams and also for re-inserting or encoding local program authorization security data into the program streams, as required by the premises owner or operator.

In one embodiment, each of the communications circuits 130A-130M include three tuners and demodulators for demodulating QPSK as well as 8-PSK signal formats and decoders for decoding MPEG standard MPEG-2 audio and video signals using a conditional access based decoding system. The audio and video signals are then encrypted using a second encryption format (e.g., Pro-Idium encryption). Each of the demodulated program streams is then re-packaged into MPEG-2 Single Program Transport Streams (SPTS) in an internet protocol format.

Communications circuits 130A-130M also receive and decode the program guide information from the satellite broadcast service provider, transmitted through the satellite system. This program guide information may be included as part of the data in one or more program streams in the satellite signal or may be a separate program stream and inserted as part of one or more of the satellite signals. The program guide information typically includes channel identification information, along with program content information for a time span (e.g., content showing at the current time plus the next 8 hours of program content for each channel). Information regarding program guide processing will be described in further detail below.

Communications circuits 130A-130M also include additional processing circuitry for receiving and transmitting signals in the internet protocol. In one embodiment, communication circuits 130A-130M include a Transmission Control Protocol/Internet Protocol (TCP/IP) server, a Dynamic Host Configuration Protocol (DHCP) client, Real-time Transport Protocol/User Datagram Protocol/Internet Protocol (RTP/UDP/IP) audio video stream server, a web server for user configuration, and a control protocol server based on Simple Object Access Protocol (SOAP) conveyed using Web Services Description Language (WSDL). Communications circuits 130A-130M also include a management control system to allow each of the communications circuits 130A-130M to operate cooperatively.

Each of the communication circuits 130A-130M outputs a single Ethernet signal in 100baseT internet protocol. The Ethernet signals from the communications circuits 130A-130M are provided to Ethernet switch 140. The Ethernet switch 140 multiplexes the signals from the communications circuits 130A-130M to generate an Ethernet packet stream. The Ethernet packet stream is then provided to modulator 160. The modulator 160 modulates the Ethernet packet stream into a signal format suitable for distribution to the rooms using the property distribution network 170 (i.e., a radio frequency (RF) network), such as a 256-QAM signal. In one embodiment, the property distribution network 170 may be a coaxial distribution system which amplifies the modulated signal and distributes the signal to each display device 180A-180P, e.g., a television.

Controller 150 provides operator access to the communications circuits 130A-130M via Ethernet switch 140. A web based interface in a web server running on the communications circuits 130A-130M permits an operator to select which received satellite channels should be shown and also what the channel numbers should be changed to, to match the channels numbers used in the facility, e.g., a hotel.

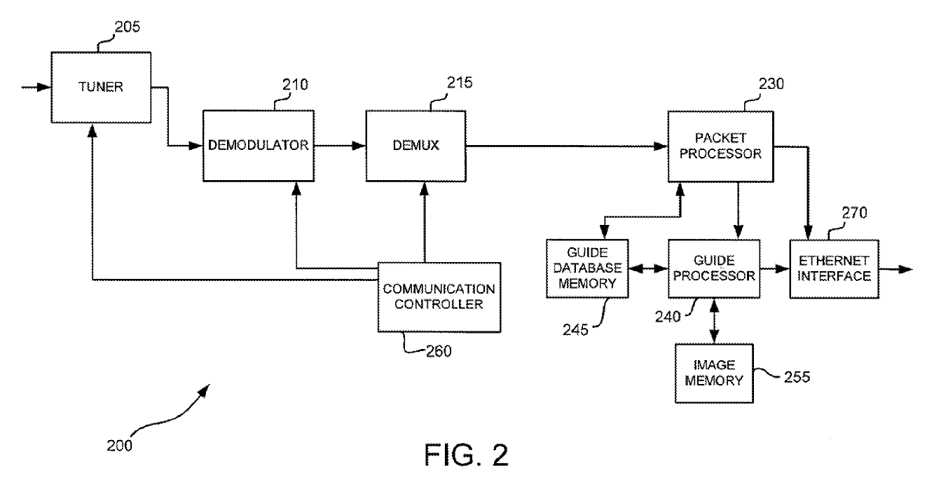

Referring to FIG. 2, a block diagram of an embodiment of a communications circuit 200, also known as a RF-to-IP circuit, for generating a program guide is provided. Tuner 205 receives at least one RF signal including program guide information from RF distribution circuit 120. The tuner 205 provides the RF signal to demodulator 210 which demodulates the RF signal to a MPEG-2 transport stream. The demodulated signal is then provided to the demultiplexer 215. The demultiplexer 215 separates the program guide information into individual pieces of data, for example, a list of selected channels, a list of programs available on the list of selected channels, times associated with the listed programs, etc. The demultiplexer 215 filters the MPEG-2 transport packets based on Packet Identifiers (PID) in each packet. The demultiplexer 215 then provides the program content information to packet processor 230 which saves the data into a database in guide database memory 245.

Guide processor 240 retrieves the program content information for the selected channels for a particular time span (e.g., the current time plus the next two hours) and converts the retrieved content to a graphical bitmap image in a red-green-blue (RGB) video signal format. It is important to note that the covered time span for the retrieved program content information may be less than the time span for program content information that is available, such as the information that has been received and stored from the service provider. The bitmap image will resemble a conventional program guide having a grid of cells where each cell includes a program available for a particular time slot. The guide processor 240 then compresses the bitmap image using a motion picture entertainment group (MPEG) compression scheme, such as MPEG-2, to create a MPEG still image that is saved in image memory 255 into a directory, e.g., a “next” directory. The “next” directory is employed as a holding directory for images as the images are generated. The images will eventually be moved into a “current” directory when all of the images have been created. The images form the “current” directory and will be provided to the room devices, such as the display devices 180A-180P. The process for providing the images will be described in further detail below. The list of channels is then scrolled by one and the process is repeated to get another MPEG still image. It is to be appreciated that the number of images generated equals the number of scroll positions to cover at least all of the channels selected. The number of images may exceed the number of channels selected if a slot or scroll position in the program guide is reserved for use other than program information, for example, a message from the service provider, or advertisements.

The MPEG images are stored in an array of files in the image memory 255 and are sent to the room devices one at a time via the Ethernet interface 270, so that the guide appears to scroll up one channel at a predetermined time interval, such as every 2.5 seconds. The predetermined time interval may alternatively be user adjustable predetermined time. The communication controller 260 uses the guide database memory 245 to know which frequency to have the tuner 205 use, which modulation type to have the demodulator 210 demodulate, and which PIDs to have the demultiplexer 215 filter, in order to properly acquire the guide information. In one embodiment, the communication controller 260 includes a web server that enables selections by an operator, via a web interface, of a predetermined number of channels from the total number of broadcast channels which will be available to an end user.

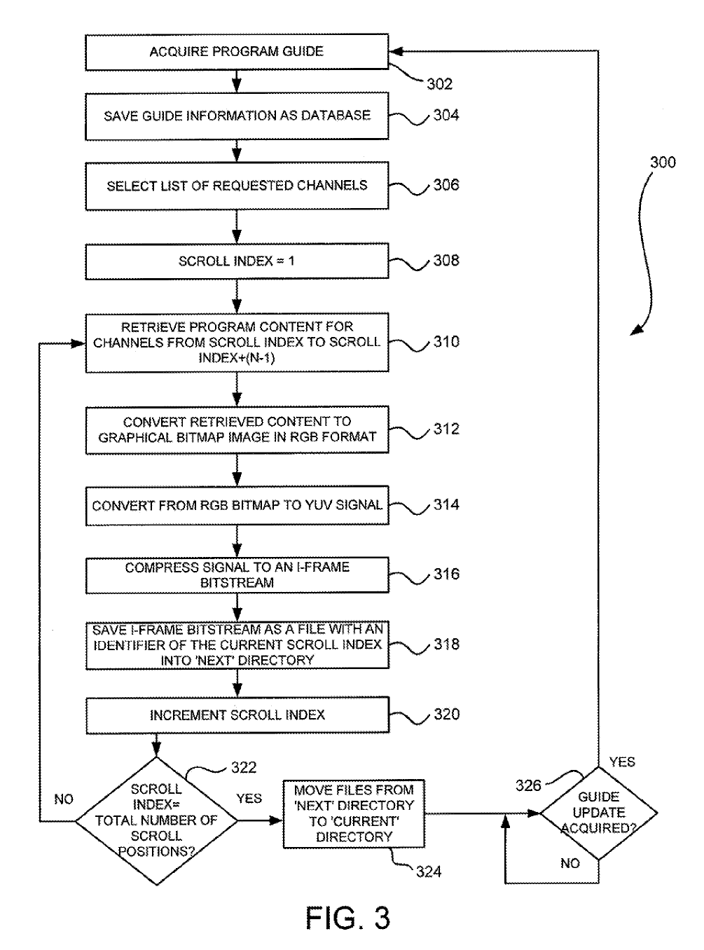

Turning to FIG. 3, a flowchart of an embodiment of a process 300 for generating program guide information is illustrated. Process 300 will primarily be described with respect to the communications circuit 200 shown in FIG. 2 but may similarly be included in the equipment found in system 100 shown in FIG. 1.

Initially, in step 302, program guide information is acquired. In one embodiment, the program content information is received as packet information in a packet stream. In step 304, the program content information is saved in a database. The program guide data may be saved as individual pieces of data, for example, a list of selected channels, a list of programs available on the list of selected channels, times associated with the listed programs, etc.

Next, in step 306, a list of requested channels from the available channels previously stored is selected. The number of channels selected is given a counter value, or scroll index value, equal to M. In one embodiment, a system operator accesses the list of available channels via a web interface. Here, the system operator selects channels that will be available to end users, e.g., at display devices or televisions. Additionally, the operator may relabel selected channels in a format more suitable for the facility where the channels are to be displayed.

In step 308, a scroll index is initialized to 1. In one embodiment, the scroll index runs from one to the total number of channels selected. In another embodiment, the scroll index runs from one to the total number of channels selected (i.e., M) plus a predetermined number of slots reserved for messages. It is to be appreciated that when the program guide is displayed, each channel will occupy one slot or scroll position. For example, if programming for nine channels is being displayed, nine slots or scroll positions will be displayed.

In step 310, the program content for the selected channels are retrieved for the channels starting at 1, i.e., the initialized scroll index, up to the scroll index plus N−1, where N is the number of channels or scroll position capable of being displayed at one time in the program guide. Continuing with the example given above, if nine channels or scroll positions can be shown, program content is retrieved for channel 1 (the current scroll index) through channel 9, where channel value 9 is derived from the scroll index of 1 plus 9 (“N”) minus 1.

In step 312, the retrieved content is converted into a graphical bitmap image in Red/Green/Blue (RGB) format. Next, in step 314, the RGB bitmap image is converted to a video signal having a luminance portion along with a blue—luminance and red—luminance difference portion (i.e., a YUV signal) which is more suitable for MPEG compression. YUV is also known as YCbCr where Y is the luminance component and U or Cb and V or Cr are the chrominance components of the color.

At step 316, the YUV bitmap signal is then compressed to form an I-frame only bitstream, using a compression algorithm. In one embodiment, an MPEG2 compression scheme for forming a stream containing only I-frames (as opposed to a stream including I-frames, B-frames, and P-frames) is employed. In step 318, the I-frame bitstream is saved as a file with the current scroll index as its name or identifier in the ‘next’ directory. As the process loops, an array of files will be saved with the scroll index incremented by 1 in the ‘next’ directory. For example, in step 320, the scroll index is incremented by 1. In step 322, the process determines if the scroll index equals the total number of scroll positions, e.g., total number of channels selected M plus any scroll positions reserved for messages. If the scroll index does not equal the total number of scroll positions, the process returns back to step 310 and will continue in the loop until an image is generated for each scroll position. For example, with the scroll index now set at 2, the program content retrieved will be for channels 2 through 10; on next pass, the program content retrieved will be for channels 3 through 11; and so on.

It is to be appreciated that at the same time the MPEG still images are being generated, a separate thread sends the MPEG still images to the TVs at the rate of a different MPEG still image at a predetermined increment or time interval, such as every 2.5 seconds.

When the scroll index does equal the total number of scroll positions, the process moves to step 324 to move the list of images just created from a “next” directory to a “current” directory. This will prevent the user from seeing images that jump backwards in time due to displaying some new and some old images with a different left edge start times. At step 326, the process will determine if an adjustable, predetermined period of time has lapsed, e.g., 5 minutes, and then determine if the guide needs to be updated. When it is determined that the guide needs to be updated, the process will revert to step 302 to generate a new set of images to be stored in the ‘next’ directory.

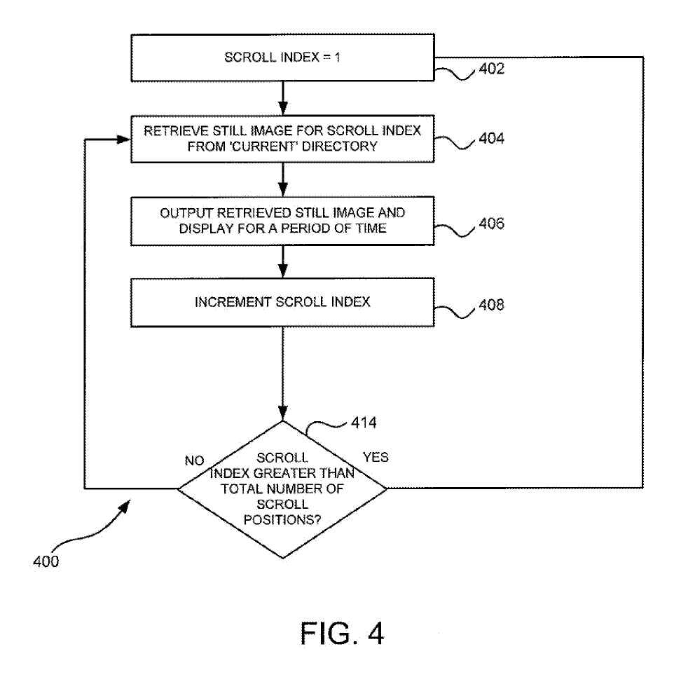

Turning to FIG. 4, a flowchart of an exemplary process 400 for displaying a program guide is shown. Process 400 will be primarily described with respect to communications circuit 200 in FIG. 2. Process 400 may also be used as part of the operation of the communications circuits 130A-130M as described in FIG. 1.

In step 402, the scroll index is set to 1. The still image identified as the image associated to the current scroll index is retrieved from the ‘current’ directory, step 404. The retrieved still image is then output to a display device, where the retrieved still image is displayed for a predetermined period of time, e.g., 2.5 seconds, in step 406. In step 408, the scroll index is increment to 1. Next, the process determines if the incremented scroll index is greater than the total number of scroll positions, i.e., the number of selected channels plus any slots reserved for messages, in step 414. If the incremented scroll index is less than the total number of scrolls, the process returns to step 404 and retrieve the next image. If the incremented scroll index is greater than the total number of scrolls, the process returns to step 402 where the scroll index is set back to 1 and the first image is retrieved.

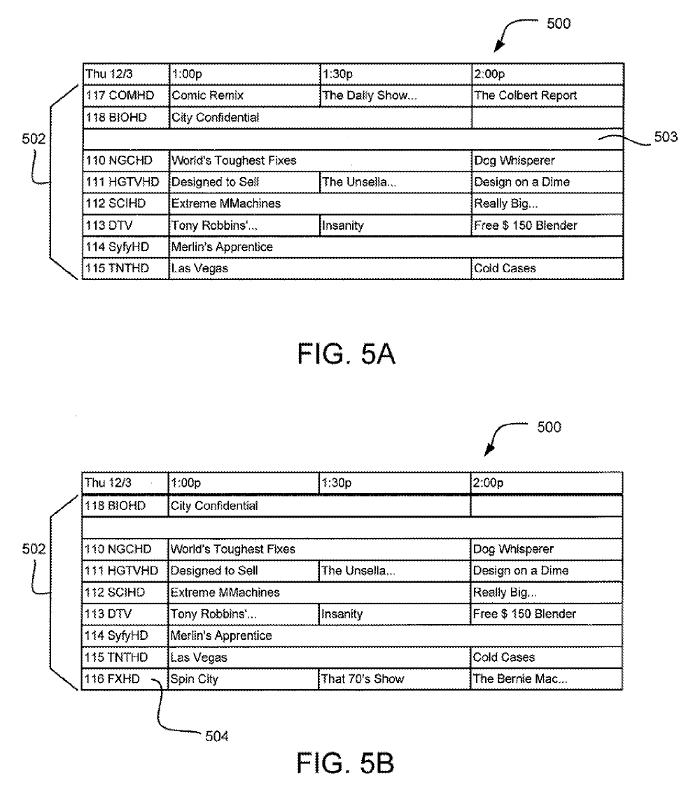

Turning now to FIGS. 5A and 5B, a display screen for the program guide information at two different time frames greater than a first time interval or increment spacing, such as 2.5 seconds, apart is illustrated. In FIG. 5A, display screen 500 includes nine (9) grid locations 502, where eight include program channels and, in this example, the ninth location, 503, is blank. It is to be appreciated that the display screen 500 shown in FIG. 5A represents a single, still image. The image shown in FIG. 5A will remain on the display device until the next image is received. The next image is shown in FIG. 5B. In the image of FIG. 5B, all of the grid locations are moved up one location with a new program channel 504 added to the bottom. As successive images are displayed, the program channels appear to incrementally scroll on the screen of the display device.

A property unique logo/bitmap can also be placed at the upper right corner or any other portion of the display 500.

The embodiments described above are directed at a system and method for providing a program guide over a multi-dwelling unit content delivery network, such as a network for broadcast and other video services that may be found in a hotel, motel, or other similar institution. The embodiments describe a system and method that converts the received program guide information from provider network, such as a satellite network, received potentially as a continuously updated stream and included as part of the program material, into an independent channel or program stream and delivered as a broadcast channel through the multi-dwelling unit network.

It is important to note that although the embodiments describe a process for displaying a guide that is incrementing by a single channel of information displayed, other incremental properties may be used. For instance, the system and process may increment by two or more channels or more reverse display order once the end of the guide (i.e. total number of scroll positions), effectively decrementing the guide scroll order. Further, although the video processing described above is primarily focused on using compression techniques used in the MPEG-2 standard, other compression standards, such as MPEG-4 may be equally applied, with the I-frames description replaced by the equivalent non-prediction based video frame portion of the compression algorithm.

Although embodiments which incorporate the teachings of the present disclosure have been shown and described in detail herein, those skilled in the art can readily devise many other varied embodiments that still incorporate these teachings. Having described preferred embodiments of a system and method for providing program guide information to an end user (which are intended to be illustrative and not limiting), it is noted that modifications and variations can be made by persons skilled in the art in light of the above teachings. It is therefore to be understood that changes may be made in the particular embodiments of the disclosure disclosed which are within the scope of the disclosure as outlined by the appended claims.

What is claimed is:

1. A method for outputting channel guide information comprising the steps of:
acquiring (302) program content information for a plurality of broadcast channels;
outputting (406) a first video image representing program content covering a time span for a first portion of the plurality of channels; and
outputting (406) a second video image representing the program content covering the time span for a second portion of the plurality of channels after outputting the first image for a time period, the second portion including at least one channel from the plurality of channels not included in the first portion.

2. The method of claim 1, further comprising saving (304) the acquired program content information in a database.

3. The method of claim 2, wherein the program content information includes at least one of a list of selected channels of the plurality of broadcast channels, a list of programs available on the list of selected channels and times associated with the listed programs.

4. The method of claim 2, further comprising:
selecting (306) a predetermined number of channels from the plurality of broadcast channels to be available to an end user, wherein the first portion and second portion of the plurality of channels equal a number of channels capable of being displayed at one period of time.

5. The method of claim 4, further comprising:
retrieving (310) the program content information from the database for the first portion of the plurality of channels, the first portion being a sequential list of the selected predetermined number of channels; and
converting (312) the retrieved program content information into a first bitmap image.

6. The method of claim 5, further comprising:
retrieving (310) the program content information from the database for the second portion of the plurality of channels, the second portion being a sequential list of the selected predetermined number of channels incremented relative to the first portion; and
converting (312) the retrieved program content information into a second bitmap image.

7. The method of claim 6, further comprising converting (314) the first and second bitmap images into first and second video signals, each of the first and second video signals including a luminance component and a chrominance component.

8. The method of claim 7, further comprising compressing (316) the first and second video signals to first and second I-frame bitstreams.

9. The method of claim 8, further comprising saving (318) the first and second I-frame bitstreams as the first and second video image.

10. The method of claim 6, further comprising converting the first and second bitmap images into a first and second portion of a compressed video stream.

11. An apparatus for outputting channel guide information comprising:
a tuner (205) that acquires program content information for a plurality of broadcast channels; and
an interface (270) that outputs a first video image representing program content covering a time span for a first portion of the plurality of channels and outputs a second video image representing the program content covering the time span for a second portion of the plurality of channels after outputting the first image for a time period, the second portion including at least one channel from the plurality of channels not included in the first portion.

12. The apparatus of claim 11, further comprising a packet processor (230) that saves the acquired program content information in a database.

13. The apparatus of claim 12, wherein the program content information includes at least one of a list of selected channels of the plurality of broadcast channels, a list of programs available on the list of selected channels and times associated with the listed programs.

14. The apparatus of claim 12, further comprising a controller (260) that selects a predetermined number of channels from the plurality of broadcast channels to be available to an end user, wherein the first portion and second portion of the plurality of channels equal a number of channels capable of being display at one period of time.

15. The apparatus of claim 14, further comprising a guide processor (240) that retrieves the program content information from the database for the first portion of the plurality of channels, the first portion being a sequential list of the selected predetermined number of channels and converts the retrieved program content information into a first bitmap image.

16. The apparatus of claim 15, wherein the guide processor (240) retrieves the program content information from the database for the second portion of the plurality of channels, the second portion being a sequential list of the selected predetermined number of channels incremented relative to the first portion and converts the retrieved program content information into a second bitmap image.

17. The apparatus of claim 16, wherein the guide processor (240) converts the first and second bitmap images into first and second video signals, each of the first and second video signals including a luminance component and a chrominance component.

18. The apparatus of claim 17, wherein the guide processor (240) compresses the first and second video signals to first and second I-frame bitstreams.

19. The apparatus of claim 18, wherein the guide processor (240) saves the first and second I-frame bitstreams as the first and second video image in an image memory.

20. The apparatus of claim 16, wherein the guide processor (240) converts the first and second bitmap images into a first and second portion of a compressed video stream.

21. An apparatus for outputting channel guide information comprising:
means for acquiring (205) program content information for a plurality of broadcast channels;
means for outputting (270) a first video image representing program content covering a time span for a first portion of the plurality of channels; and
means for outputting (270) a second video image representing the program content covering the time span for a second portion of the plurality of channels after outputting the first image for a time period, the second portion including at least one channel from the plurality of channels not included in the first portion.
